(19) United States
(12) Patent Application Publication
(10) Pub. No.: US 2012/0196043 A1
(43) Pub. Date: Aug. 2, 2012

(54) METHOD FOR PRODUCING HEAT-TREATED LIQUID CRYSTAL POLYESTER-IMPREGNATED BASE MATERIAL

(75) Inventor: Shohei AZAMI, Tsukuba-shi (JP)

(73) Assignee: SUMITOMO CHEMICAL COMPANY, LIMITED, Tokyo (JP)

(21) Appl. No.: 13/315,501

(22) Filed: Dec. 9, 2011

(30) Foreign Application Priority Data
Jan. 28, 2011 (JP) 2011-016447

(51) Int. Cl. B05D 3/02; C03C 17/32

(52) U.S. Cl. 427/389.8; 427/444

(57) ABSTRACT

An object of the present invention is to provide a method for producing a heat-treated liquid crystal polyester-impregnated base material, which can prevent welding to a supporting material upon a heat treatment. A second liquid crystal polyester-impregnated base material is obtained by heat-treating a first liquid crystal polyester-impregnated base material 11 arranged on a supporting material 13 through a resin layer 12 which exhibits a melting point of 320° C. or higher by the measurement using a differential scanning calorimeter, or does not undergo decomposition at lower than 320° C. and also does not exhibit a melting point.

### BACKGROUND OF THE INVENTION

(1) Field of the Invention

The present invention relates to a method for producing a heat-treated liquid crystal polyester-impregnated base material.

(2) Description of Related Art

A liquid crystal polyester-impregnated base material can be produced, for example, by impregnating a base material such as a glass cloth with a liquid crystal polyester solution, and then removing a solvent. Such a liquid crystal polyester-impregnated base material has hitherto been examined as the material of an insulating layer of a printed circuit board (printed board, printed circuit board) to be assembled into various electronic instruments since it has high heat resistance and strength and also has excellent dimensional stability and low dielectric loss (see, for example, International Publication No. WO 2008/143455). When the liquid crystal polyester-impregnated base material is used as the material of the insulating layer, it is ordinary that the liquid crystal polyester-impregnated base material is subjected to a heat treatment in advance thereby increasing the molecular weight, and then hot-pressed thereby laminating together with a metal foil.

However, there was a problem that the liquid crystal polyester-impregnated base material is welded to the supporting material by a heat treatment when the liquid crystal polyester-impregnated base material is directly arranged on a supporting material such as a tray made of metal.

Under these circumstances, the present invention has been made and an object thereof is to provide a method for producing a heat-treated liquid crystal polyester-impregnated base material, which can prevent welding to a supporting material upon a heat treatment.

In order to solve the problem, the present invention provides a method for producing a heat-treated liquid crystal polyester-impregnated base material, which comprises the step of heat-treating a liquid crystal polyester-impregnated base material arranged on a supporting material through a resin layer which exhibits a melting point of 320° C. or higher by the measurement using a differential scanning calorimeter, or does not undergo decomposition at lower than 320° C. and also does not exhibit a melting point.

In the method for producing a heat-treated liquid crystal polyester-impregnated base material according to the present invention, the material of the resin layer is one or more kinds selected from the group consisting of aramid, polyetherimide, polyimide, liquid crystal polymer and polytetrafluoroethylene.

In the method for producing a heat-treated liquid crystal polyester-impregnated base material according to the present invention, the liquid crystal polyester includes repeating units represented by the following formulas (1), (2) and (3):

—O—Ar¹—CO—, (1)

—CO—Ar²—CO—, and (2)

—X—Ar³—Y— (3)

wherein Ar¹ represents a phenylene group, a naphthylene group or a biphenylylene group; Ar² and Ar³ each independently represents a phenylene group, a naphthylene group, a biphenylylene group or a group represented by the following formula (4); X and Y each independently represents an oxygen atom or an imino group; and one or more hydrogen atoms existing in Ar¹, Ar² or Ar³ each independently may be substituted with a halogen atom, an alkyl group or an aryl group, and

—Ar⁴—Z—Ar⁵ (4)

wherein Ar⁴ and Ar⁵ each independently represents a phenylene group or a naphthylene group; and Z represents an oxygen atom, a sulfur atom, a carbonyl group, a sulfonyl group or an alkylidene group.

In the method for producing a heat-treated liquid crystal polyester-impregnated base material according to the present invention, the liquid crystal polyester preferably includes 30 to 80 mol % of a repeating unit represented by the formula (1), 10 to 35 mol % of a repeating unit represented by the formula (2) and 10 to 35 mol % of a repeating unit represented by the formula (3), based on the total amount of all repeating units constituting the liquid crystal polyester.

In the method for producing a heat-treated liquid crystal polyester-impregnated base material according to the present invention, X and/or Y is/are imino group(s) in the general formula (3).

In the method for producing a heat-treated liquid crystal polyester-impregnated base material according to the present invention, the liquid crystal polyester preferably includes a repeating unit derived from p-hydroxybenzoic acid and a repeating unit derived from 2-hydroxy-6-naphthoic acid in the total content of 30.0 to 45.0 mol %, repeating units derived from one or more compounds selected from the group consisting of terephthalic acid, isophthalic acid and 2,6-naphthalenedicarboxylic acid in the total content of 25.0 to 35.0 mol %, and a repeating unit derived from 4-aminophenol in the total content of 25.0 to 35.0 mol %, based on the total amount of all repeating units constituting the liquid crystal polyester.

In the method for producing a heat-treated liquid crystal polyester-impregnated base material according to the present invention, the liquid crystal polyester-impregnated base material is obtained by impregnating a glass cloth with a liquid crystal polyester.

According to the present invention, it is possible to provide a method for producing a heat-treated liquid crystal polyester-impregnated base material, which can prevent welding to a supporting material upon a heat treatment.

### BRIEF DESCRIPTION OF THE DRAWINGS

FIGS. 1A and 1B are schematic views each showing an arrangement form of a liquid crystal polyester-impregnated base material on a supporting material upon a heat treatment in an embodiment of the present invention, in which FIG. 1A is a perspective view and FIG. 1B is a sectional view taken along line A-A of FIG. 1A; and

FIGS. 2A and 2B are schematic views each showing another arrangement form of a liquid crystal polyester-impregnated base material on a supporting material upon a heat treatment in an embodiment of the present invention, in which FIG. 2A is a perspective view and FIG. 2B is a sectional view taken along line B-B of FIG. 2A.

### DETAILED DESCRIPTION OF THE INVENTION

The present invention will be described in detail below.

The method for producing a heat-treated liquid crystal polyester-impregnated base material of the present invention (hereinafter referred to as a “second liquid crystal polyester-impregnated base material”) is characterized by including the step of heat-treating a liquid crystal polyester-impregnated base material (hereinafter referred to as a “first liquid crystal polyester-impregnated base material”) arranged on a supporting material through a resin layer which exhibits a melting point of 320° C. or higher by the measurement using a differential scanning calorimeter, or does not undergo decomposition at lower than 320° C. and also does not exhibit a melting point.

The second liquid crystal polyester-impregnated base material is obtained by increasing the molecular weight of a liquid crystal polyester in the first liquid crystal polyester-impregnated base material through the heat treatment.

There is no particular limitation on the supporting material as long as it can stably support a first liquid crystal polyester-impregnated base material upon a heat treatment. The material of the supporting material may be any material having heat resistance, and examples thereof include metals such as aluminum; alloys such as stainless steel (SUS); and ceramics such as alumina. The shape of the supporting material may be any shape which can support a first liquid crystal polyester-impregnated base material, such as tray shape, plate shape or container shape.

There is no particular limitation on the material of the resin layer as long as it exhibits a melting point of 320° C. or higher, or it does not undergo decomposition at lower than 320° C. and also does not exhibit a melting point, and the material of the resin layer may be appropriately selected taking the temperature upon a heat treatment into consideration. The term “does not exhibit a melting point” mainly means that it is decomposed.

Specific examples of preferable material of the resin layer include aramid, polyetherimide, polyimide, liquid crystal polymer and polytetrafluoroethylene from the viewpoint of particularly excellent heat resistance.

The resin layer may be fixed on the supporting material or not. For example, when the resin layer is not fixed on the supporting material, since the resin layer can also be replaced by the other one after using predetermined times, there is an advantage that the supporting material can be repeatedly used multiple times. When the resin layer is not fixed on the supporting material, for example, the resin layer may be merely mounted on the supporting material.

Examples of preferable method in which the first liquid crystal polyester-impregnated base material is arranged on a supporting material through the resin layer include a method (i) in which a sheet-shaped or plate-shaped resin layer is arranged on a supporting material and also a first liquid crystal polyester-impregnated base material is arranged on the resin layer, and (ii) a method in which a first liquid crystal polyester-impregnated base material is arranged on the resin layer of the supporting material on which the resin layer was coated.

The resin layer may be a single layer, or two or more layers. In case of two or more layers, the combination and ratio may be appropriately selected according to the purposes.

There is no particular limitation on the thickness of the resin layer, and the thickness is preferably from 20 to 500 μm. When the resin layer is two or more layers, the thickness of the resin layer means the total thickness of all resin layers. When the thickness of the resin layer is lower limit or more, the strength of the resin layer is more enhanced and thus higher welding prevention effect of the second liquid crystal polyester-impregnated base material can be obtained. Handling properties are more improved by adjusting the thickness to the upper limit or less.

The arrangement (contact) site of the first liquid crystal polyester-impregnated base material on the surface of the resin layer preferably has a surface roughness of 0.1 μm or less. When the surface roughness is within such a range, the obtained second liquid crystal polyester-impregnated base material may be peeled off more easily from the resin layer after a heat treatment. Also, transfer of a surface pattern of the resin layer is suppressed and smoothness of a contact surface with the resin layer is more improved. The surface roughness can be measured by a known method. For example, the surface roughness can be measured under conditions such as contact mode using an atomic force microscope (AFM).

The resin layer which is not fixed on the supporting material can be produced, for example, in the same manner as in a member made of a resin, such as a sheet or plate made of a conventional resin.

The supporting material coated with a resin layer can be produced by a known method and can be produced, for example, by applying curable composition which would serve as a raw material of the resin layer to a surface of the supporting material, followed by curing.

The first liquid crystal polyester-impregnated base material can be produced, for example, by impregnating a base material with a liquid composition containing a liquid crystal polyester and a solvent, and then removing a solvent from the obtained composition-impregnated base material. The liquid crystal polyester is a liquid crystal polyester which exhibits mesomorphism in a molten state, and is preferably melted at a temperature of 450° C. or lower. The liquid crystal polyester may be a liquid crystal polyester amide, a liquid crystal polyester ether, a liquid crystal polyester carbonate, or a liquid crystal polyester imide. The liquid crystal polyester is preferably a wholly aromatic liquid crystal polyester obtained by using only an aromatic compound as a raw monomer.

Typical examples of the liquid crystal polyester include:

(I) those obtained by polymerization (polycondensation) of an aromatic hydroxycarboxylic acid, an aromatic dicarboxylic acid, and at least one kind of compound selected from the group consisting of an aromatic diol, an aromatic hydroxyamine and an aromatic diamine;

(II) those obtained by polymerization of plural kinds of aromatic hydroxycarboxylic acids;

(III) those obtained by polymerization of an aromatic dicarboxylic acid, and at least one kind of compound selected from the group consisting of an aromatic diol, an aromatic hydroxyamine and an aromatic diamine; and

(IV) those obtained by polymerization of a polyester such as polyethylene terephthalate, and an aromatic hydroxycarboxylic acid. Herein, there may be used a polymerizable derivative thereof in place of a part or all of the aromatic hydroxycarboxylic acid, aromatic dicarboxylic acid, aromatic diol, aromatic hydroxyamine and aromatic diamine, each independently.

Examples of the polymerizable derivative of the compound having a carboxyl group such as an aromatic hydroxycarboxylic acid or aromatic dicarboxylic acid include those obtained by converting a carboxyl group into an alkoxycarbonyl group or an aryloxycarbonyl group (ester); those obtained by converting a carboxyl group into a haloformyl group (acid halide); and those obtained by converting a carboxyl group into an acyloxycarbonyl group (acid anhydride).

Examples of the polymerizable derivative of the compound having a hydroxyl group such as an aromatic hydroxycarboxylic acid, an aromatic diol or an aromatic hydroxyamine include those obtained by converting a hydroxyl group into an acyloxyl group through acylation (acylated product).

Examples of the polymerizable derivative of the compound having an amino group such as an aromatic hydroxyamine or an aromatic diamine include those obtained by converting an amino group into an acylamino group through acylation (acylated product).

The liquid crystal polyester preferably includes a repeating unit represented by the following formula (1) (hereinafter may be sometimes referred to a “repeating unit (1)”), and more preferably includes repeating unit (1), a repeating unit represented by the following formula (2) (hereinafter may be sometimes referred to a “repeating unit (2)”) and a repeating unit represent by the following formula (3) (hereinafter may be sometimes referred to a “repeating unit (3)”):

—O—Ar¹—CO—, (1)

—CO—Ar²—CO—, and (2)

—X—Ar³—Y— (3)

wherein Ar¹ represents a phenylene group, a naphthylene group or a biphenylylene group; Ar² and Ar³ each independently represents a phenylene group, a naphthylene group, a biphenylylene group or a group represented by the following formula (4); X and Y each independently represents an oxygen atom or an imino group; and one or more hydrogen atoms existing in Ar¹, Ar² or Ar³ each independently may be substituted with a halogen atom, an alkyl group or an aryl group, and

—Ar⁴—Z—Ar⁵ (4)

wherein Ar⁴ and Ar⁵ each independently represents a phenylene group or a naphthylene group; and Z represents an oxygen atom, a sulfur atom, a carbonyl group, a sulfonyl group or an alkylidene group.

Examples of the halogen atom include a fluorine atom, a chlorine atom, a bromine atom and an iodine atom.

Examples of the alkyl group include a methyl group, an ethyl group, an n-propyl group, an isopropyl group, an n-butyl group, an isobutyl group, an s-butyl group, a t-butyl group, an n-pentyl group, an n-hexyl group, an n-heptyl group, a 2-ethylhexyl group, an n-octyl group, an n-nonyl group and an n-decyl group, and the number of carbon atoms is preferably from 1 to 10.

Examples of the aryl group include a phenyl group, an o-tolyl group, an m-tolyl group, a p-tolyl group, a 1-naphthyl group and a 2-naphthyl group, and the number of carbon atoms is preferably from 6 to 20.

When the hydrogen atom is substituted with these groups, the number thereof is independently preferably 2 or less, and more preferably 1 or less, respectively, every group represented by Ar¹, Ar² or Ar³.

Examples of the alkylidene group include a methylene group, an ethylidene group, an isopropylidene group, an n-butylidene group and a 2-ethylhexylidene group, and the number of carbon atoms is preferably from 1 to 10.

The repeating unit (1) is a repeating unit derived from a predetermined aromatic hydroxycarboxylic acid. The repeating unit (1) is preferably a repeating unit in which Ar¹ is a p-phenylene group (a repeating unit derived from a p-hydroxybenzoic acid), or a repeating unit in which Ar¹ is a 2,6-naphthylene group (a repeating unit derived from 6-hydroxy-2-naphthoic acid).

The repeating unit (2) is a repeating unit derived from a predetermined aromatic dicarboxylic acid. The repeating unit (2) is preferably a repeating unit in which Ar² is a p-phenylene group (a repeating unit derived from terephthalic acid), a repeating unit in which Ar² is a m-phenylene group (a repeating unit derived from isophthalic acid), a repeating unit in which Ar² is a 2,6-naphthylene group (a repeating unit derived from 2,6-naphthalenedicarboxylic acid), or a repeating unit in which Ar² is a diphenylether-4,4′-diyl group (a repeating unit derived from diphenylether-4,4′-dicarboxylic acid).

The repeating unit (3) is a repeating unit derived from a predetermined aromatic diol, an aromatic hydroxylamine or an aromatic diamine. The repeating unit (3) is preferably a repeating unit in which Ar³ is a p-phenylene group (a repeating unit derived from hydroquinone, p-aminophenol or p-phenylenediamine), or a repeating unit in which Ar³ is a 4,4′-biphenylylene group (a repeating unit derived from 4,4′-dihydroxybiphenyl, 4-amino-4′-hydroxybiphenyl or 4,4′-diaminobiphenyl).

The content of the repeating unit (1) is preferably 30 mol % or more, more preferably 30 to 80 mol %, still more preferably from 30 to 60 mol %, and particularly preferably from 30 to 40 mol %, based on the total amount of all repeating units constituting a liquid crystal polyester (value in which the mass of each repeating unit constituting a liquid crystal polyester is divided by a formula weight of each repeating unit thereof to determine the amount (mol) corresponding to the amount of a substance of each repeating unit, and then the obtained amounts are totaled).

The content of the repeating unit (2) is preferably 35 mol % or less, more preferably from 10 to 35 mol %, still more preferably from 20 to 35 mol %, and particularly preferably from 30 to 35 mol %, based on the total amount of all repeating units constituting a liquid crystal polyester.

The content of the repeating unit (3) is preferably 35 mol % or less, more preferably from 10 to 35 mol %, still more preferably from 20 to 35 mol %, and particularly preferably from 30 to 35 mol %, based on the total amount of all repeating units constituting a liquid crystal polyester.

As the content of the repeating unit (1) increases, heat resistance as well as strength and rigidity are likely to be improved. However, when the content is too large, solubility in a solvent is likely to decrease.

A ratio of the content of the repeating unit (2) to the content of the repeating unit (3) is preferably from 0.9/1 to 1/0.9, more preferably from 0.95/1 to 1/0.95, and still more preferably from 0.98/1 to 1/0.98, in terms of [content of the repeating unit (2)]/[content of the repeating unit (3)] (mol/mol).

The liquid crystal polyester may include two or more kinds of each of the repeating units (1) to (3), independently. The liquid crystal polyester may include a repeating unit other than the repeating units (1) to (3), and the content thereof is preferably 10 mol % or less, and more preferably 5 mol % or less, based on the total amount of all repeating units constituting a liquid crystal polyester.

The liquid crystal polyester preferably includes, as the repeating unit (3), a repeating unit in which X and/or Y is/are imino group(s), that is, a repeating unit derived from a predetermined aromatic hydroxylamine and/or a repeating unit derived from aromatic diamine, and more preferably includes, as the repeating unit (3), only a repeating unit in which X and/or Y is/are imino group(s). Whereby, the obtained liquid crystal polyester exhibits more excellent solubility in a solvent.

The liquid crystal polyester preferably includes a repeating unit derived from p-hydroxybenzoic acid and a repeating unit derived from 2-hydroxy-6-naphthoic acid in the total amount of 30.0 to 45.0 mol % based on the total amount of all repeating units constituting the liquid crystal polyester.

The liquid crystal polyester preferably includes a repeating unit derived from one or more compounds selected from the group consisting of terephthalic acid, isophthalic acid and 2,6-naphthalenedicarboxylic acid in the total amount of 25.0 to 35.0 mol % based on the total amount of all repeating units constituting the liquid crystal polyester.

The liquid crystal polyester preferably includes a repeating unit derived from 4-aminophenol in an amount of 25.0 to 35.0 mol % based on the total amount of all repeating units constituting the liquid crystal polyester. The liquid crystal polyester preferably includes all repeating units in such a ratio.

The liquid crystal polyester is preferably produced by melt-polymerizing a raw monomer corresponding to a repeating unit constituting the liquid crystal polyester, and subjecting the obtained polymer (prepolymer) to solid phase polymerization. Whereby, it is possible to produce a high-molecular weight liquid crystal polyester having excellent heat resistance as well as high strength and rigidity with satisfactory operability. The melt polymerization may be carried out in the presence of a catalyst, and examples of the catalyst include metal compounds such as magnesium acetate, stannous acetate, tetrabutyl titanate, lead acetate, sodium acetate, potassium acetate and antimony trioxide; and nitrogen-containing heterocylic compounds such as 4-(dimethylamino)pyridine and 1-methylimidazol. Among these catalysts, nitrogen-containing heterocylic compounds are preferably used.

The flow initiation temperature of the liquid crystal polyester is preferably 250° C. or more, more preferably from 250 to 350° C., and still more preferably from 260 to 330° C. As the flow initiation temperature increases, heat resistance as well as strength and rigidity are likely to be improved. However, when the flow initiation temperature is too high, solubility in the solvent is likely to decrease and the viscosity of the liquid composition is likely to increase.

The flow initiation temperature is also called a flow temperature and means a temperature at which a melt viscosity becomes 4,800 Pa·s (48,000 poise) when a liquid crystal polyester is melted while heating at a heating rate of 4° C./min under a load of 9.8 MPa (100 kg/cm²) and extruded through a nozzle having an inner diameter of 1 mm and a length of 10 mm using a capillary rheometer, and the flow initiation temperature serves as an index indicating a molecular weight of the liquid crystal polyester (see “Liquid Crystalline Polymer—Synthesis, Molding, and Application” edited by Naoyuki Koide, page 95, published by CMC Publishing CO., LTD., issued on Jun. 5, 1987).

The liquid composition contains a liquid crystal polyester and a solvent. The solvent is appropriately selected from those which can dissolve the liquid crystal polyester used, specifically a solvent which can dissolve in the concentration ([liquid crystal polyester]/[liquid crystal polyester+solvent]×100) of 1% by mass or more at 50° C.

Examples of the solvent include halogenated hydrocarbons such as dichloromethane, chloroform, 1,2-dichloroethane, 1,1,2,2,-tetrachloroethane and o-dichlorobenzene; phenol halides such as p-chlorophenol, pentachlorophenol and pentafluorophenol; ethers such as diethylether, tetrahydrofuran and 1,4-dioxane; ketones such as acetone and cyclohexanone; esters such as ethyl acetate and γ-butyrolactone; carbonates such as ethylene carbonate and propylene carbonate; amines such as triethylamine; nitrogen-containing heterocyclic aromatic compounds such as pyridine; nitriles such as acetonitrile and succinonitrile; amide-based solvents (organic solvents having an amide bond) such as N,N-dimethylformamide, N,N-dimethylacetamide and N-methylpyrrolidone, urea compounds such as tetramethylurea; nitro compound such as nitromethane and nitrobenzene; sulfur compounds such as dimethyl sulfoxide and sulfolane; and phosphorus compounds such as hexamethylphosphoric acid amide and tri-n-butylphosphoric acid. Two or more kinds of these solvents may be used.

The solvent is preferably a solvent containing, as a main component, an aprotic compound, and particularly an aprotic compound having no halogen atom, since the solvent is easily handled because of low corrosion resistance. The content of the aprotic compound in the entire solvent is preferably from 50 to 100% by mass, more preferably from 70 to 100% by mass, and still more preferably from 90 to 100% by mass.

It is preferred to use, as the aprotic compound, amide-based solvents such as N,N-dimethylformamide, N,N-dimethylacetamide and N-methylpyrrolidone since it is easy to dissolve the liquid crystal polyester.

The solvent is preferably a solvent containing, as a main component, a compound having a dipole moment of 3 to 5 since it is easy to dissolve the liquid crystal polyester. The content in the entire solvent of the compound having a dipole moment of 3 to 5 is preferably 50 to 100% by weight, more preferably from 70 to 100% by weight, and still more preferably from 90 to 100% by weight. It is preferred to use, as the aprotic compound, a compound having a dipole moment of 3 to 5.

The solvent is preferably a solvent containing, as a main component, a compound having a boiling point at 1 atom of 220° C. or lower since it is easy to remove. The content in the entire solvent of the compound having a boiling point at 1 atom of 220° C. or lower is preferably from 50 to 100% by weight, more preferably from 70 to 100% by weight, and still more preferably from 90 to 100% by weight. It is preferred to use, as the aprotic compound, a compound having a boiling point at 1 atom of 220° C. or lower.

The content of liquid crystal polyester in the liquid composition is preferably from 5 to 60% by mass, more preferably from 10 to 50% by mass, and further more preferably from 15 to 45% by mass, based on the total amount of the liquid crystal polyester and solvent, and the content is appropriately adjusted so as to obtain a liquid composition having a desired viscosity.

The liquid composition may contain one or more kinds of other components such as a filler, an additive, and a resin other than the liquid crystal polyester.

Examples of the filler include inorganic fillers such as silica, alumina, titanium oxide, barium titanate, strontium titanate, aluminum hydroxide and calcium carbonate; and organic fillers such as a hardened epoxy resin, a crosslinked benzoguanamine resin and a crosslinked acrylic resin. The content of the filler is preferably from 0 to 100 parts by mass based on 100 parts by mass of the liquid crystal polyester.

Examples of the additive include a leveling agent, defoamer, an antioxidant, an ultraviolet absorber, a flame retardant and a coloring agent. The content thereof is preferably from 0 to 5 parts by mass based on 100 parts by mass of the liquid crystal polyester.

Examples of the resin other than the liquid crystal polyester include thermoplastic resins such as polypropylene, polyamide, polyester other than the liquid crystal polyester, polyphenylene sulfide, polyetherketone, polycarbonate, polyethersulfone, polyphenyleneether and polyetherimide; and thermosetting resins such as a phenol resin, an epoxy resin, a polyimide resin and a cyanate resin. The content thereof is preferably from 0 to 20 parts by mass based on 100 parts by mass of the liquid crystal polyester.

The liquid composition can be prepared by mixing a liquid crystal polyester, a solvent, and other components to be optionally used, collectively or in a suitable order. When the filler is used as other components, the liquid composition is preferably prepared by dissolving the liquid crystal polyester in the solvent to obtain a liquid crystal polyester solution, and then dispersing a filler in this liquid crystal polyester solution.

The material of the base material to be impregnated with the liquid crystal polyester may be any one of an inorganic fiber and an organic fiber, and is preferably in a sheet form.

The base material made of the inorganic fiber is preferably a sheet made mainly of a glass fiber, that is, a glass cloth.

The base material made of the organic fiber is preferably a sheet made of polybenzoxide, aramid, liquid crystal polymer and the like.

The glass cloth is preferably made of an alkali-containing glass fiber, a non-alkali glass fiber or a low dielectric glass fiber. The fiber constituting the glass cloth may be partially mixed with a ceramic fiber made of ceramics other than glass, or a carbon fiber. The fiber constituting the glass cloth may be surface-treated with a coupling agent such as an aminosilane-based coupling agent, an epoxysilane-based coupling agent or a titanate-based coupling agent.

Examples of the method for producing a glass cloth made of these fibers include a method in which a fiber constituting a glass cloth is dispersed in water and a sizing agent such as an acrylic resin is optionally added, and sheet making using a paper machine and then drying to obtain a nonwoven fabric, and a method in which a known weaving machine is used.

It is possible to use, as a technique of weaving a fiber, a plain weaving, satin weaving, twill weaving and mat weaving techniques. The weaving density is preferably 10 to 100 fibers/25 mm.

The mass per unit area of the glass cloth is preferably from 10 to 300 g/m².

The thickness of the glass cloth is preferably from 10 to 200 and more preferably from 10 to 180 μm.

The glass cloth may be a commercially available product. Examples of the glass cloth as a commercially available product which is easily available include those for an insulating impregnated base material of electronic components and are available from Asahi-SCHWEBEL Co., LTD., Nitto Boseki Co., Ltd., Arisawa Manufacturing Co., Ltd. and the like.

Examples of the commercially available glass cloth with a suitable thickness include those with IPC names of 1035, 1078, 2116 and 7628.

Examples of the method of impregnating the base material with the liquid composition include a method in which the base material is immersed in the liquid composition in an immersion tank. In this method, it is possible to easily control the amount of a liquid crystal polyester, with which the base material is impregnated, by appropriately adjusting the content of the crystal polyester of the liquid composition, the immersion time, and the rate of taking up of the immersed base material from the liquid composition.

There is no particular limitation on the method of removing the solvent from the composition-impregnated base material, and the method is preferably a method of vaporization of the solvent from the viewpoint of a simple operation. Examples of the method include a method in which vaporization is carried out by using any one of heating, depression and ventilation alone, or using two or more kinds of them in combination.

The step of heat-treating a first liquid crystal polyester-impregnated base material is preferably carried out under an atmosphere of an inert gas such as nitrogen. The heating temperature upon a heat treatment is lower than 320° C., and preferably from 240 to 310° C., and the heating time is preferably from 1 to 30 hours. From the viewpoint of obtaining a second liquid crystal polyester-impregnated base material having more satisfactory heat resistance, the heating temperature is preferably 250° C. or higher, and more preferably from 260 to 310° C. From the viewpoint of an improvement in productivity, the heating time is preferably from 1 to 10 hours.

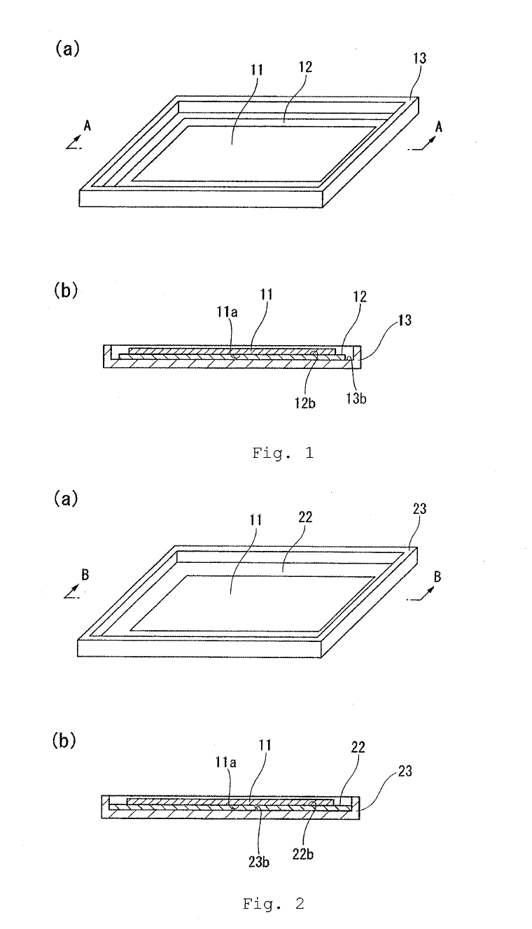

FIGS. 1A and 1B are schematic views each showing an arrangement form of a liquid crystal polyester-impregnated base material on a supporting material in an embodiment of the present invention, in which FIG. 1A is a perspective view and FIG. 1B is a sectional view taken along line A-A of FIG. 1A.

The arrangement form shown herein is a specific example of an arrangement method of the above (i), and a tray-shaped material is used as a supporting material and a single layered sheet-like layer is used as a resin layer, respectively. More specifically, the arrangement form is as follows.

A resin sheet 12 is mounted on a supporting material 13, and the resin sheet 12 is not fixed to the supporting material 13. A first liquid crystal polyester-impregnated base material 11 to be heat-treated is mounted on the resin sheet 12, and the first liquid crystal polyester-impregnated base material 11 is not fixed to the resin sheet 12. In the first liquid crystal polyester-impregnated base material 11, the surface (supporting surface, bottom surface) 11a facing the supporting material 13 is in contact with a top surface 12b of the resin sheet 12, and is arranged so that any position thereof is not directly contacted with a bottom surface 13b of the supporting material 13.

It is not necessarily required that the entire bottom surface 11a of the first liquid crystal polyester-impregnated base material 11 is in contact with a top surface 12b of a resin sheet, and a gap portion may exist between the base material and the top surface 12b of the resin sheet as long as it is arranged on the resin sheet 12.

The first liquid crystal polyester-impregnated base material 11 is preferably arranged without bending on a resin sheet 12. Whereby, the obtained second liquid crystal polyester-impregnated base material is also without bending and thus handling properties are improved.

FIG. 1 shows an example in which the resin sheet 12 is not fixed to a supporting material 13 and the first liquid crystal polyester-impregnated base material 11 is not fixed to a resin sheet 12. However, the resin sheet 12 may be fixed to the supporting material 13, and the first liquid crystal polyester-impregnated base material 11 may be fixed to the resin sheet 12. There is no particular limitation on the fixing method, and examples thereof include a method in which they are fixed with each other using a heat-resistant adhesive tape.

The drawing shows, as the resin sheet 12, an example in which a surface area of a top surface 12 is smaller than a surface area of a bottom surface 13b of a supporting material 13. However, the surface area of the resin sheet 12 may be equal to or more than the surface area of the supporting material 13. The surface area of the resin sheet 12 can be optionally adjusted if the first liquid crystal polyester-impregnated base material 11 to be arranged has the size which may not cause direct contact with the supporting material 13.

The drawing also shows an example in which one first liquid crystal polyester-impregnated base material 11 is arranged on one supporting material 13. However, two or more first liquid crystal polyester-impregnated base materials 11 may be arranged on one supporting material 13.

FIGS. 2A and 2B are schematic views each showing another arrangement form of a liquid crystal polyester-impregnated base material on a supporting material in an embodiment of the present invention, in which FIG. 2A is a perspective view and FIG. 2B is a sectional view taken along line B-B of FIG. 2A.

The arrangement form shown herein is a specific example of an arrangement method of the above (ii), and a tray-shaped supporting material in which a single-layered resin layer is coated on a bottom surface is used. More specifically, the arrangement form is as follows.

A resin layer 22 is coated on the bottom surface 23b of a supporting material 23, and the first liquid crystal polyester-impregnated base material 11 to be heat-treated is mounted on the resin layer 22 and first liquid crystal polyester-impregnated base material 11 is not fixed to the resin layer 22. In the first liquid crystal polyester-impregnated base material 11, the surface (supporting surface, bottom surface) 11a facing the resin layer 22 is in contact with a top surface 22b of the resin sheet 22, and is arranged so that any position thereof is not directly contacted with a bottom surface 23b of the supporting material 23.

It is not necessarily required that the entire bottom surface 11a of the first liquid crystal polyester-impregnated base material 11 is in contact with a top surface 22b of a resin layer, and a gap portion may exist between the base material and the top surface 22b of the resin sheet as long as it is arranged on the resin layer 22.

FIG. 2 shows an example in which the first liquid crystal polyester-impregnated base material 11 is not fixed to the resin layer 22. However, the base material may be fixed to the resin layer 22. There is no particular limitation on the fixing method, and the method may be the same as that described in FIG. 1.

The drawing shows, as the resin layer 22, an example in which the entire bottom surface 23b of the supporting material is coated. However, the coating site of the resin layer 22 may not be the entire bottom surface 23b of the supporting material, and the surface area of the top surface 22b of the resin layer can be optionally adjusted if the liquid crystal polyester-impregnated base material 11 to be arranged has the size which may not cause direct contact with the supporting material 23.

The drawing also shows an example in which one first liquid crystal polyester-impregnated base material 11 is arranged on one supporting material 23. However, two or more first liquid crystal polyester-impregnated base materials 11 may be arranged on one supporting material 23.

FIGS. 1 to 2 show an arrangement form when a tray-shaped supporting material is used as a support. However, such an arrangement form is suited to carry out a heat treatment of the first liquid crystal polyester-impregnated base material in a “batchwise manner”. In this case, plural supporting materials in which the first liquid crystal polyester-impregnated base material is arranged may be arranged (laminated) in a vertical direction at regular intervals with each other, or a horizontal direction, or a combination thereof.

In contrast, when a heat treatment of the first liquid crystal polyester-impregnated base material is carried out in a “continuous manner”, for example, it is possible to exemplify a method in which a heat treatment is carried out by an apparatus configured to deliver a long first liquid crystal polyester-impregnated base material from a delivery roll and to take up around a take-up roll through a conveying roll corresponding to the supporting material on the way using, as the conveying roll, a conveying roll provided with the same resin layer as in the case of the batchwise manner on the conveying surface. In this case, the number of the conveying rolls can be optionally selected according to the purposes.

According to the present invention, since the resin layer exhibits a melting point of 320° C. or higher by the measurement using a differential scanning calorimeter, or does not undergo decomposition at lower than 320° C. and also does not exhibit a melting point, the resin layer does not accompany deterioration such as melting or decomposition at a temperature lower than 320° C. which is usually required in a heat treatment of the first liquid crystal polyester-impregnated base material. It is possible for the second liquid crystal polyester-impregnated base material to prevent from welding to the supporting material upon a heat treatment through such a resin layer. As a result, surface roughening and transfer of a surface pattern of the supporting material due to peeling of the welding site are suppressed without deterioration of appearance of the second liquid crystal polyester-impregnated base material. Since welding to the resin layer is also prevented, it is easy to peel off from the resin layer after the heat treatment.

### EXAMPLES

The present invention will be described in further detail below by way of specific Examples. However, the present invention is not limited to the following Examples.

### Production of First Liquid Crystal Polyester-Impregnated Base Material

### Production Example 1

### (1) Production of Liquid Crystal Polyester

In a reactor equipped with a stirrer, a torque meter, a nitrogen gas introducing tube, a thermometer and a reflux condenser, 1,976 g (10.5 mol) of 2-hydroxy-6-naphthoic acid, 1,474 g (9.75 mol) of 4-hydroxyacetoanilide, 1,620 g (9.75 mol) of isophthalic acid and 2,374 g (23.25 mol) of acetic anhydride were charged. After replacing the gas in the reactor by a nitrogen gas, the temperature was raised to 150° C. over 15 minutes under a nitrogen gas flow and the mixture was refluxed while maintaining the same temperature (150° C.) for 3 hours.

Then, while distilled off by-produced acetic acid and the unreacted acetic anhydride, the temperature was raised to 300° C. over 170 minutes. At the time when an increase in torque is recognized was regarded as completion of the reaction, and contents were taken out. The contents were cooled to room temperature and crushed by a crusher to obtain a liquid crystal polyester powder having comparatively low molecular weight. With respect to the thus obtained powder, the flow initiation temperature was measured by Flow Tester “Model CFT-500” (manufactured by Shimadzu Corporation). As a result, it was 235° C. Solid phase polymerization was carried out by heat-treating the liquid crystal polyester powder under a nitrogen atmosphere at 223° C. for 3 hours. After the solid phase polymerization, the liquid crystal polyester showed a flow initiation temperature of 270° C.

### (2) Production of First Liquid Crystal Polyester-Impregnated Base Material

The obtained liquid crystal polyester (2,200 g) was added to N,N-dimethylacetamide (DMAc) (7,800 g), followed by heating at 100° C. for 2 hours to obtain a liquid composition. This liquid composition showed a solution viscosity of 320 cP. This melt viscosity is the value obtained by measuring at a measuring temperature of 23° C., using B type viscometer “Model TVL-20” (rotor No. 21, a rotational speed of 5 rpm, manufactured by Toki Sangyo Co., Ltd.).

A glass cloth (thickness of 45 μm, IPC name of 1078, manufactured by Arisawa Manufacturing Co., Ltd.) was impregnated with the thus obtained liquid composition to produce a composition-impregnated base material, and the composition-impregnated base material was dried by a hot-air dryer at a set temperature of 160° C. to obtain a first liquid crystal polyester-impregnated base material.

### Production of Second Liquid Crystal Polyester-Impregnated Base Material

### Example 1

As shown in FIG. 1, a first liquid crystal polyester-impregnated base material was arranged on a supporting material and then subjected to a heat treatment to produce a second liquid crystal polyester-impregnated base material. Specifically, the production procedure is as follows.

A polytetrafluoroethylene (PTFE) sheet (thickness of 300 μm, manufactured by Industry Co., Ltd.) having a melting point measured by a differential scanning calorimeter (DSC-50, manufactured by Shimadzu Corporation) of 327° C. was laid on a bottom surface of a tray made of SUS (Model number: SUS430) and the first liquid crystal polyester-impregnated base material obtained in Production Example 1 was placed flat thereon, facing one surface toward the PTFE sheet. Then, the molecular weight of the liquid crystal polyester in the first liquid crystal polyester-impregnated base material was increased by a heat treatment in an oven under a nitrogen gas atmosphere at 290° C. for 3 hours to produce a second liquid crystal polyester-impregnated base material.

### Example 2

As shown in FIG. 1, a first liquid crystal polyester-impregnated base material was arranged on a supporting material and then subjected to a heat treatment to produce a second liquid crystal polyester-impregnated base material. Specifically, the production procedure is as follows.

A polyimide film (UPILEX, thickness 25 μm, manufactured by Ube Industries, Ltd.), which does not exhibit a melting point by a differential scanning calorimeter (DSC-50, manufactured by Shimadzu Corporation) in which decomposition at a temperature lower than 320° C. is not recognized, was laid on a bottom surface of a tray made of SUS (Model number: SUS430), and the first liquid crystal polyester-impregnated base material obtained in Production Example 1 was placed flat thereon, facing one surface toward the polyimide film. Then, the molecular weight of the liquid crystal polyester in the first liquid crystal polyester-impregnated base material was increased by a heat treatment in an oven under a nitrogen gas atmosphere at 290° C. for 3 hours to produce a second liquid crystal polyester-impregnated base material.

### Comparative Example 1

The first liquid crystal polyester-impregnated base material obtained in Production Example 1 was directly placed flat on a bottom surface of this tray made of SUS, facing one surface toward the tray made of SUS (Model number: SUS430). Then, the molecular weight of a liquid crystal polyester in the first liquid crystal polyester-impregnated base material was increased by carrying out a heat treatment in an oven at 290° C. for 3 hours under a nitrogen gas atmosphere to produce a second liquid crystal polyester-impregnated base material.

### <Evaluation of Second Liquid Crystal Polyester-Impregnated Base Material>

Appearance of the second liquid crystal polyester-impregnated base material obtained above was visually observed, and then the presence or absence of welding of the second liquid crystal polyester-impregnated base material to a supporting material (tray made of SUS) or a resin layer (PTFE sheet, polyimide film), and the presence or absence of transfer of a surface pattern from a tray or resin layer were confirmed. The evaluation results are shown in Table 1.

TABLE 1

| | | | Second liquid crystal | |
|---|---|---|---|---|
| | | Resin layer | polyester-impregnated | |
| | Supporting | (arrangement | base material | |
| | material | form) | Welding | Transfer |
| Example 1 | Tray made | PTFE sheet | Not | Not |
| | of SUS | (mounted) | occurred | occurred |
| Example 2 | Tray made | Polyimide | Not | Not |
| | of SUS | sheet | occurred | occurred |
| | | (mounted) | | |
| Comparative | Tray made | — | Occurred | Occurred |
| Example 1 | of SUS | | | |

As is apparent from the results shown in Table 1, in Examples 1 to 2, welding of the second liquid crystal polyester-impregnated base material to both supporting material and resin layer was not recognized and could be easily peeled off from the resin layer, and transfer of a surface pattern from both supporting material and resin layer was not recognized. As described above, according to the present invention, the second liquid crystal polyester-impregnated base material having satisfactory appearance was obtained.

In contrast, in Comparative Example 1, the second liquid crystal polyester-impregnated base material was welded to the supporting material and transfer of the surface pattern from the supporting material was recognized, and appearance was poor.

The present invention can be utilized for the production of an insulating layer in a printed circuit board for an electronic instrument.

What is claimed is:

1. A method for producing a heat-treated liquid crystal polyester-impregnated base material, which comprises the step of heat-treating a liquid crystal polyester-impregnated base material arranged on a supporting material through a resin layer which exhibits a melting point of 320° C. or higher by the measurement using a differential scanning calorimeter, or does not undergo decomposition at lower than 320° C. and also does not exhibit a melting point.

2. The method for producing a heat-treated liquid crystal polyester-impregnated base material according to claim 1, wherein the material of the resin layer is one or more kinds selected from the group consisting of aramid, polyetherimide, polyimide, liquid crystal polymer and polytetrafluoroethylene.

3. The method for producing a heat-treated liquid crystal polyester-impregnated base material according to claim 1, wherein the liquid crystal polyester includes repeating units represented by the following formulas (1), (2) and (3):
—O—Ar¹—CO—, (1)
—CO—Ar²—CO—, and (2)
—X—Ar³—Y— (3)
wherein Ar¹ represents a phenylene group, a naphthylene group or a biphenylylene group; Ar² and Ar³ each independently represents a phenylene group, a naphthylene group, a biphenylylene group or a group represented by the following formula (4); X and Y each independently represents an oxygen atom or an imino group; and one or more hydrogen atoms existing in Ar¹, Ar² or Ar³ each independently may be substituted with a halogen atom, an alkyl group or an aryl group, and
—Ar⁴—Z—Ar⁵ (4)
wherein Ar⁴ and Ar⁵ each independently represents a phenylene group or a naphthylene group; and Z represents an oxygen atom, a sulfur atom, a carbonyl group, a sulfonyl group or an alkylidene group.

4. The method for producing a heat-treated liquid crystal polyester-impregnated base material according to claim 1, wherein the liquid crystal polyester includes 30 to 80 mol % of a repeating unit represented by the formula (1), 10 to 35 mol % of a repeating unit represented by the formula (2) and 10 to 35 mol % of a repeating unit represented by the formula (3), based on the total amount of all repeating units constituting the liquid crystal polyester.

5. The method for producing a heat-treated liquid crystal polyester-impregnated base material according to claim 1, wherein X and/or Y is/are imino group(s) in the general formula (3).

6. The method for producing a heat-treated liquid crystal polyester-impregnated base material according to claim 1, wherein the liquid crystal polyester includes a repeating unit derived from p-hydroxybenzoic acid and a repeating unit derived from 2-hydroxy-6-naphthoic acid in the total content of 30.0 to 45.0 mol %, repeating units derived from one or more compounds selected from the group consisting of terephthalic acid, isophthalic acid and 2,6-naphthalenedicarboxylic acid in the total content of 25.0 to 35.0 mol %, and a repeating unit derived from 4-aminophenol in the total content of 25.0 to 35.0 mol %, based on the total amount of all repeating units constituting the liquid crystal polyester.

7. The method for producing a heat-treated liquid crystal polyester-impregnated base material according to claim 1, wherein the liquid crystal polyester-impregnated base material is obtained by impregnating a glass cloth with a liquid crystal polyester.
